(19) United States
(12) Patent Application Publication
(10) Pub. No.: US 2021/0143505 A1
(43) Pub. Date: May 13, 2021

(54) ENERGY STORAGE APPARATUS

(71) Applicant: GS Yuasa International Ltd., Kyoto-shi (JP)

(72) Inventor: Tsuyoshi HIDAKA, Kyoto-shi, Kyoto (JP)

(21) Appl. No.: 16/481,426

(22) PCT Filed: Dec. 25, 2017
(86) PCT No.: PCT/JP2017/046337

§ 371 Date: Jul. 26, 2019

(30) Foreign Application Priority Data
Feb. 3, 2017 (JP) 2017-018798

(51) Int. Cl. H01M 50/202; H01M 50/134; H01M 50/209; H01M 50/147; H01M 10/0525

(52) U.S. Cl. CPC H01M 50/202; H01M 50/134; H01G 11/12; H01M 50/147; H01M 10/0525; H01M 50/209

(57) ABSTRACT

An energy storage apparatus includes a plurality of energy storage devices each including an electrode assembly and a container in which the electrode assembly is accommodated, the energy storage devices being disposed in a predetermined arrangement direction in a laminated manner. The plurality of energy storage devices includes a pair of first energy storage devices located at outermost ends in the arrangement direction and second energy storage devices located between the pair of first energy storage devices. Rigidity of the container of the first energy storage device is higher than rigidity of the container of the second energy storage device.

### TECHNICAL FIELD

The present invention relates to an energy storage apparatus.

### BACKGROUND ART

There has been known an energy storage apparatus (lithium ion battery) having an energy storage device in which electrode sheets are disposed in a laminated manner in an outer case. Although a lithium ion battery is lightweight as compared with a lead-acid battery, the lithium ion battery has a problem in that the energy storage device expands. In the energy storage apparatus disclosed in Patent Document 1, a reinforcing plate provided on an outer peripheral wall of an outer case suppresses deformation and breakage of the outer case due to expansion of an energy storage device. In the energy storage apparatus disclosed in Patent Document 2, restricting movement of a plurality of energy storage devices using a reinforcing plate suppresses deformation and breakage of an outer case due to expansion of an energy storage device.

### PRIOR ART DOCUMENTS

### Patent Documents

Patent Document 1: JP-A-2002-117815
Patent Document 2: JP-A-2007-42648

### SUMMARY OF THE INVENTION

### Problems to be Solved by the Invention

However, since a reinforcing plate with high rigidity is heavy, an advantage of a lithium ion battery is not utilized in the energy storage apparatuses disclosed in Patent Documents 1 and 2, in which the reinforcing plate encloses the energy storage devices. Therefore, there is room specifically for reducing an entire weight of the energy storage apparatuses disclosed in Patent Documents 1 and 2.

An object of the present invention is to provide an energy storage apparatus capable of reducing an entire weight of the energy storage apparatus while suppressing expansion of an energy storage device.

### Means for Solving the Problems

An aspect of the present invention provides an energy storage apparatus including a plurality of energy storage devices each including: an electrode assembly; and a container in which the electrode assembly is accommodated, the energy storage devices being disposed in a predetermined arrangement direction in a laminated manner, wherein the plurality of energy storage devices includes: a pair of first energy storage devices located at outermost ends in the arrangement direction; and a second energy storage device located between the pair of first energy storage devices, and rigidity of the container of the first energy storage device is higher than rigidity of the container of the second energy storage device.

According to this energy storage apparatus, the rigidity of the container of the first energy storage device that comes into surface contact with an outer case is higher than the rigidity of the container of the second energy storage device in the middle part. Therefore, local expansion of the container due to deterioration of the electrode assembly of the first energy storage device is suppressed by the rigidity of the first energy storage device. As a result, a load due to the expansion is hardly applied to a connecting portion between the container and a cover body, and thus safety of the energy storage device can be improved. Moreover, among the plurality of energy storage devices, only the pair of first energy storage devices located at the outermost ends is formed to have high rigidity. Therefore, the entire weight of the energy storage apparatus can be reduced. Furthermore, deformation of the outer case of the energy storage apparatus due to the expansion of the energy storage device can be suppressed without changing strength of the outer case.

The container of the first energy storage device includes a first surface facing the adjacent second energy storage device, and a second surface on an opposite side of the first surface, and a reinforcing plate is fixed to the second surface. According to this aspect, the rigidity of the first energy storage device can be easily increased at a low cost as compared with a case where a thickness of the container of the first energy storage device is increased. Furthermore, a force acting from the first energy storage device toward the outer case is applied to the end face of the outer case in a dispersed manner through the reinforcing plate. Therefore, local expansion of the container due to deterioration of the electrode assembly can be suppressed.

The energy storage device desirably has a cover body sealing an opening of the container, and the reinforcing plate is desirably fixed to the container in a position where a predetermined space is left with respect to the cover body.

Alternatively, the reinforcing plate is desirably fixed to the container in a position where a predetermined space is left with respect to a bottom portion on an opposite side of the opening of the container.

Alternatively, the container desirably has a long side surface extending in a direction crossing the arrangement direction to form the second surface, and a short side surface extending along the arrangement direction, and the reinforcing plate is desirably fixed to the long side surface in a position where a predetermined space is left with respect to the short side surface.

According to these aspects, a fixing portion (connecting portion) comes close to a central portion where a deformation amount of the container is large. This can narrow a deformable area of the container. Therefore, expansion of the energy storage device can be effectively suppressed.

The reinforcing plate is desirably fixed to the container at a connecting portion by welding, and the connecting portion is desirably formed in a portion of the container that is not in contact with the electrode assembly. According to this aspect, when the reinforcing plate is fixed after assembly of the energy storage device, influence of heat on the electrode assembly during welding can be suppressed.

### Advantages of the Invention

In the energy storage apparatus of the present invention, the rigidity of the container of the first energy storage device that comes into surface contact with the outer case is higher than the rigidity of the container of the second energy storage device in a middle part. Therefore, local expansion of the container due to the deterioration of the electrode assembly of the first energy storage device can be effectively suppressed. Moreover, among the plurality of energy storage devices, only the first energy storage devices located at the outermost ends are formed to have high rigidity. Therefore, the entire weight of the energy storage apparatus can be reduced.

### BRIEF DESCRIPTION OF THE DRAWINGS

FIG. 1 is a plan view of an energy storage apparatus according to a first embodiment of the present invention.

FIG. 2 is a partial cross-sectional view of a first battery cell.

FIG. 3 is an exploded perspective view of a battery cell.

FIG. 4A is a front view of the first battery cell.

FIG. 4B is a side view of the first battery cell in FIG. 4A.

FIG. 5A is a side view showing how the first battery cell and a reinforcing plate are deformed.

FIG. 5B is a perspective view showing how a long side surface portion of the first battery cell is deformed.

FIG. 5C is a perspective view showing how a long side surface portion of a conventional battery cell is deformed.

FIG. 6 is a front view showing a first battery cell of an energy storage apparatus of a second embodiment.

FIG. 7 is a front view showing a first battery cell of an energy storage apparatus of a third embodiment.

FIG. 8 is a front view showing a first battery cell of an energy storage apparatus of a fourth embodiment.

FIG. 9 is a side view showing a first battery cell of an energy storage apparatus of a fifth embodiment.

FIG. 10 is an exploded perspective view showing a modification of the battery cell.

FIG. 11 is a cross-sectional view showing a modification of the energy storage apparatus.

### MODE FOR CARRYING OUT THE INVENTION

Hereinafter, embodiments of the present invention will be described with reference to the drawings.

### First Embodiment

FIG. 1 shows an energy storage apparatus 10 according to a first embodiment of the present invention. The energy storage apparatus 10 includes an outer case 12 and a battery module 18 accommodated in the outer case 12. The battery module 18 includes a plurality of battery cells 20 (twelve battery cells 20 in the present embodiment). In the present invention, rigidity of a pair of battery cells 20A located at outermost ends in an arrangement direction is made higher than rigidity of battery cells 20B in the middle part. As a result, an entire weight of the energy storage apparatus 10 is reduced while expansion of the battery cells 20A is suppressed.

### (Overall Structure of Energy Storage Apparatus)

As shown in FIG. 1, the outer case 12 has a case main body 13 made of resin with one face (top face) open, and a cover (not shown) sealing an opening of the case main body 13. The case main body 13 is a box that includes a pair of long side walls 14, 14 extending along an XZ plane in FIG. 1, and a pair of short side walls 15, 15 extending along a YZ plane in FIG. 1. The cover includes a positive electrode external terminal and a negative electrode external terminal, and is fixed to the opening of the case main body 13 in a liquid-tight and airtight manner.

The battery module 18 includes the battery cells 20, each serving as an energy storage device, disposed along a longitudinal direction (X direction) of the outer case 12 in a laminated manner. The battery cell 20 is a nonaqueous electrolyte secondary battery such as a lithium ion battery. Note that, in addition to a lithium ion battery, various types of battery cell 20 including a capacitor are applicable. This battery cell 20 is a box for which the Y direction in FIG. 1 is the longitudinal direction and the X direction in FIG. 1 is a lateral direction. One end of the battery cell 20 in the Y direction is provided with a positive electrode terminal 31 and the other end of the battery cell 20 in the Y direction is provided with a negative electrode terminal 32.

Bus bars 50A to 50E, each serving as a conductive member, are connected to the positive electrode terminals 31 and the negative electrode terminals 32 of the adjacent battery cells 20 by welding. In the case of a parallel connection, the positive electrode terminals 31 of predetermined battery cells 20 are electrically connected to each other, and the negative electrode terminals 32 of predetermined battery cells 20 are electrically connected to each other. In the case of a series connection, the positive electrode terminal 31 of a predetermined battery cell 20 is electrically connected to the negative electrode terminal 32 of a predetermined battery cell 20. FIG. 1 shows an aspect, as an example, in which twelve battery cells 20 are used in total, three battery cells 20 among them are connected in parallel, and four sets, each of which includes the three battery cells 20 connected in parallel, are connected in series.

Three of the battery cells 20 from one end to the other end of the case main body 13 in the Y direction are considered as one set. In this case, the plurality of battery cells 20 is disposed so that the battery cells 20 adjacent to each other in the same set have the same terminal polarity, and the battery cells 20 adjacent to each other across adjacent sets have reverse terminal polarities. A group of the negative electrode terminals 32 of a first set located on a left side end in FIG. 1 is connected in parallel by a first bus bar 50A. A group of the positive electrode terminals 31 of the first set is connected to a group of the negative electrode terminals 32 of a second set in series by a second bus bar 50B. A group of the positive electrode terminals 31 of the second set is connected to a group of the negative electrode terminals 32 of a third set in series by a third bus bar 50C. A group of the positive electrode terminals 31 of the third set is connected to a group of the negative electrode terminals 32 of a fourth set in series by a fourth bus bar 50D. A group of the positive electrode terminals 31 of the fourth set located on a right side end in FIG. 1 is connected in parallel by a fifth bus bar 50E.

The first bus bar 50A connected to the group of the negative electrode terminals 32 of the first set is electrically connected to the negative electrode external terminal of the cover, and the fifth bus bar 50E connected to the group of the positive electrode terminals 31 of the fourth set is electrically connected to the positive electrode external terminal of the cover. This enables each of the battery cells 20 to charge and discharge electricity via the positive electrode external terminal and the negative electrode external terminal.

### (Details of Battery Cell)

As shown in FIGS. 2 and 3, each of the battery cells 20 includes a case 21, an electrode assembly 35, and a pair of current collectors 45A, 45B.

The case 21 includes a container 23 having a flat box shape with one face (top face) open, and a cover body 30 sealing an opening 27 of the container 23. The container 23 and the cover body 30 are both made of aluminum or stainless steel. The container 23 has a bottom face portion 24 having a substantially rectangular shape extending along an XY plane. In the bottom face portion 24, a long side surface portion 25 is provided in each of a pair of long sides in a raised manner, and a short side surface portion 26 is provided in each of a pair of short sides in a raised manner. The long side surface portion 25 is disposed in the case main body 13 along the direction Y orthogonal to the predetermined arrangement direction X of the battery cell 20. The short side surface portion 26 has a total length (width) shorter than that of the long side surface portion 25, and is disposed in the case main body 13 along the arrangement direction X. The cover body 30 has a rectangular shape whose size is equal to that of the bottom face portion 24, and seals by welding the opening 27 of the container 23 located on the opposite side of the bottom face portion 24. The positive electrode terminal 31 and the negative electrode terminal 32 are provided in this cover body 30.

The electrode assembly 35 is a flat winding having a positive electrode assembly 36 serving as a positive electrode sheet, a negative electrode assembly 37 serving as a negative electrode sheet, and two sheets of separators 38, 38 in a laminated manner, and is wound around a winding shaft Wa. An active material 36a is applied to a band-shaped substrate made of aluminum foil to form the positive electrode assembly 36. An active material 37a is applied to a band-shaped substrate made of copper foil to form the negative electrode assembly 37. The separator 38 is made of a porous resin film and is disposed between the positive electrode assembly 36 and the negative electrode assembly 37 to electrically insulate these electrode assemblies from each other.

An end portion 39 of the electrode assembly 35, as viewed from an extending direction of the winding shaft Wa, has an elliptic shape, and has a pair of straight lines 40, 40 opposed to each other, and a pair of curved portions 41, 41 opposed to each other so as to connect the straight lines 40, 40. The electrode assembly 35 is accommodated in the container 23 in such a posture that the winding shaft Wa is disposed along the longitudinal direction (Y direction) of the case 21. As a result, the band-shaped positive electrode assembly 36 and negative electrode assembly 37 are laminated in the X direction from one of the long side surface portions 25 to the other long side surface portion 25. Moreover, the straight line 40 and the curved portion 41 extend in the Y direction along the winding shaft Wa.

The positive electrode current collector 45A electrically connects the positive electrode assembly 36 to the positive electrode terminal 31, and the negative electrode current collector 45B electrically connects the negative electrode assembly 37 to the negative electrode terminal 32. The positive electrode current collector 45A is made of metal such as aluminum, and the negative electrode current collector 45B is made of metal such as copper. The current collectors 45A, 45B each include a flat plate-shaped pedestal portion 46 and a pair of leg portions 47, 47 bifurcated and extending from the pedestal portion 46. The pedestal portion 46 is disposed between the cover body 30 and the electrode assembly 35, and is connected to the terminal 31 or 32 of the cover body 30 by swaging, for example. The leg portions 47 are disposed on the end portion 39 of the electrode assembly 35, and are connected to the end portion 39 while sandwiching and compressing the end portion 39.

Although the battery cell 20 is hardly deformable even when a compressing force is applied in the X direction, which is a lamination direction of the electrode assembly 35, the battery cell 20 is easily deformable when an expanding force is applied in the X direction. Hereinafter, descriptions will be made assuming that two battery cells located at outermost ends of the battery module 18 in the arrangement direction X are battery cells 20A and that battery cells in the middle part excluding these battery cells 20A are battery cells 20B. Movement of the battery cell 20B in the X direction is restricted by connection of the bus bars 50A to 50E, and expansion of the battery cell 20B in the X direction is restricted by the adjacent battery cell 20B. However, an outer side of the battery cell 20A faces the case main body 13 made of resin that is elastically deformable, and therefore expansion of the battery cell 20A in the X direction cannot be restricted. In the present embodiment, a reinforcing plate 52 is disposed on the battery cell 20A in order to restrict the expansion of the battery cell 20A and deformation of the case main body 13 caused thereby.

### (Description of Reinforcing Plate)

Referring to FIGS. 4A and 4B together with FIG. 2, the reinforcing plate 52 is configured to increase rigidity of the container 23, and is a rectangular plate material having a predetermined thickness and made of metal identical to the container 23 (aluminum or stainless steel). The larger the thickness of the reinforcing plate 52 in the X direction, the better. However, when the reinforcing plate 52 is too thick, the energy storage apparatus 10 becomes heavy. Therefore, desirably, the thickness of the reinforcing plate 52 is substantially equal to that of the container 23. A height of the reinforcing plate 52 in the Z direction is equal to a total height of the long side surface portion 25, and a width of the reinforcing plate 52 in the Y direction is equal to a width of the long side surface portion 25.

The reinforcing plate 52 is fixed to, among the long side surface portions 25, 25 of the battery cell 20A as the first energy storage device, an outer surface (second surface) 25b on the opposite side of an inner surface (first surface) 25a facing the battery cell 20B, which is the adjacent second energy storage device. Although the reinforcing plate 52 may be fixed before assembly of the battery cell 20A, the reinforcing plate 52 is desirably fixed after assembly of the battery module 18 connected by the bus bars 50A to 50E as shown in FIG. 1. This is because the battery cell 20A to which the reinforcing plate 52 is fixed in advance becomes an exclusive component that can only be disposed at the outermost end of the battery module 18, and thus assembly workability of the battery module 18 is impaired.

The reinforcing plate 52 is fixed to the long side surface portion 25 by welding. As most clearly shown in FIG. 2, the reinforcing plate 52 is disposed on the long side surface portion 25 and is welded by, for example, a laser from the side of the reinforcing plate 52 to form a connecting portion 53 in which a part of the long side surface portion 25 is integrated with a part of the reinforcing plate 52. The connecting portion 53 is formed in a portion of the long side surface portion 25 that is not in contact with the electrode assembly 35. Specifically, referring to FIG. 4B, the curved portion 41 of the electrode assembly 35 gradually goes away from the long side surface portion 25 as departing from the winding shaft Wa. Referring to FIG. 2, the end portion 39 of the electrode assembly 35 is separated from the long side surface portion 25 by being sandwiched between the leg portions 47, 47 of the current collectors 45A, 45B. Therefore, a portion where the electrode assembly 35 comes in contact with the long side surface portion 25 is a rectangular planar portion 42 (hatched area with two-dot chain lines in FIG. 4A) located between the curved portions 41, 41 and between the end portions 39, 39. Forming the connecting portion 53 in a portion located on an outer side of the planar portion 42 suppresses influence of heat on the electrode assembly 35 during welding.

Furthermore, the connecting portion 53 is formed in a position where a predetermined space is left with respect to a peripheral portion of the long side surface portion 25. Specifically, on a side of the cover body 30 of the battery cell 20A, the connecting portion 53 is formed in a position where a space D1 is left with respect to the cover body 30. On a side of the bottom face portion 24 of the battery cell 20A, the connecting portion 53 is formed in a position where a space D2 is left with respect to the bottom face portion 24. On a side of the short side surface portion 26 of the battery cell 20A, the connecting portion 53 is formed in a position where a space D3 is left with respect to the short side surface portion 26. The spaces D1 to D3 are desirably as large as possible, as long as the connecting portion 53 is not located in the planar portion 42. In the present embodiment, the connecting portion 53 on the side of the cover body 30 is formed so as to be located midway between the electrode assembly 35 and the cover body 30. The connecting portion 53 on the side of the bottom face portion 24 is formed in a portion where the curved portion 41 is located. The connecting portion 53 on the side of the short side surface portion 26 is formed in a portion where the current collector 45A or 45B is located.

As shown in FIG. 1, when the battery cells 20A, 20B are accommodated in the case main body 13, the movement on both sides of the battery cell 20B in the middle part in the X direction is restricted by the other battery cells 20A or 20B. Therefore, the battery cell 20B does not expand in the X direction even when an unintended abnormality occurs in the electrode assembly 35. The battery cell 20A at the outermost end expands outward in the X direction when an unintended abnormality occurs in the electrode assembly 35. In this case, the reinforcing plate 52 comes in surface contact with the short side wall 15. As a result, a force exerted by expansion from the battery cell 20A toward the outer case 12 is applied to the short side wall 15 in a dispersed manner through the reinforcing plate 52. Therefore, local expansion of the battery cell 20A due to deterioration of the electrode assembly 35 can be suppressed.

As a result, a load due to the expansion is hardly applied to the connecting portion between the container 23 and the cover body 30. Therefore, breakage of the connecting portion can be prevented, and thus safety of the battery cell 20A can be improved. Moreover, among the plurality of battery cells 20A, 20B, the reinforcing plate 52 is disposed only on each of the battery cells 20A located at the outermost ends. Therefore, the entire weight of the energy storage apparatus 10 can be reduced as compared with the case where a reinforcing plate is disposed so as to enclose four sides of the battery cells. Furthermore, deformation of the outer case 12 of the energy storage apparatus 10 due to the expansion of the battery cells 20A can be suppressed without changing strength (rigidity) of the outer case 12. In addition, since the reinforcing plate 52 can improve the rigidity of the battery cells 20A as described below, local expansion of the battery cells 20A due to deterioration of the electrode assembly 35 can be effectively suppressed.

FIG. 5A shows how the battery cell has deformed due to expansion. A solid line in FIG. 5A shows the battery cell 20A in the present embodiment in which the reinforcing plate 52 is fixed to the long side surface portion 25 by means of the connecting portion 53. A thick solid line in FIG. 5A shows a surface shape of the long side surface portion 25 of the deformed battery cell 20A. A broken line in FIG. 5A shows a surface shape of a long side surface portion 25′ of a conventional battery cell (Patent Document 1). A conventional reinforcing plate is not fixed to a long side surface portion by means of a connecting portion, but fixed to an outer case so as to be simply lateral to the long side surface portion. Needless to say, the shapes of the long side surface portions 25, 25′ are identical.

In FIG. 5B, deformation of the long side surface portion 25 of the battery cell 20A of the present embodiment shown in FIG. 5A is expressed with contours. In FIG. 5C, deformation of the long side surface portion 25′ of the conventional battery cell shown in FIG. 5A is expressed with contours. Referring to FIGS. 5B and 5C, contours Va located in the outermost peripheral portion each indicate a root of the deformation, contours Vb located in the innermost peripheral portion each indicate a vicinity of a top that protrudes most due to deformation, and centers of the innermost peripheral portions Vb are the tops having maximum deformation amounts V1, V2. As described above, the deformation of the long side surface portions 25, 25′ due to the expansion of the battery cell 20A gradually increases from the outermost peripheral portion Va toward the top in the center.

Referring to FIGS. 5A to 5C, in both cases of the battery cell 20A of the present embodiment and the conventional battery cell, the deformation amount of the long side surface portions 25, 25′ due to the expansion is largest in a central portion away from the peripheral portion. The maximum deformation amount V1 of the battery cell 20A of the present embodiment, in which the reinforcing plate 52 is fixed by means of the connecting portion 53, is equal to or less than half of the maximum deformation amount V2 of the battery cell in the conventional example. This is because the connecting portions 53 are formed in positions where the spaces D1 to D3 are left with respect to the long side surface portion 25. That is, bringing the connecting portions 53 close to the central portion that has a large deformation amount narrows an area where the long side surface portion 25 is deformable. Accordingly, the expansion of the battery cell 20A can be effectively suppressed.

Moreover, in the present embodiment, an area of the reinforcing plate 52 is identical to that of the long side surface portion 25 on the YZ plane. With this configuration, the reinforcing plate 52 exists in a range of the spaces D1 to D3 shown in FIG. 4A. Here, in the reinforcing plate 52, the outer portion located outside the connecting portions 53 (range of the spaces D1 to D3) has a smaller deformation amount in the X direction than the central portion located inside the connecting portions 53 as shown in FIG. 5A. Since the outer portion in the range of the spaces D1 to D3 having a small deformation amount comes into contact with the long side surface portion 25 of the battery cell 20A, the battery cell 20A can further strongly be reinforced.

As described above, in the present embodiment, the battery cell 20A can also be reinforced by the outer portion (portion of the spaces D1 to D3) of the connecting portion 53 in the reinforcing plate 52. As a result, the expansion of the battery cell 20A can be further effectively suppressed. Moreover, because the connecting portion 53 is formed in a portion of the long side surface portion 25 that is not in contact with the electrode assembly 35, the influence of heat on the electrode assembly 35 during welding can be suppressed. Furthermore, the reinforcing plate 52 made of metal can serve as a heat sink and release heat that may cause deterioration (expansion) of the battery cell 20A. Accordingly, the energy storage apparatus 10 capable of suppressing the expansion of all the battery cells 20A and 20B and reducing the entire weight of the energy storage apparatus 10 can be realized.

### Second Embodiment

FIG. 6 shows a battery cell 20A of an energy storage apparatus of a second embodiment. The battery cell 20A is different from that of the first embodiment only in a method for welding a reinforcing plate 52 to a long side surface portion 25, and other structures are the same as those of the first embodiment. In the second embodiment, a first connecting portion 53A having a line shape and extending laterally along a cover body 30, and a second connecting portion 53B having a line shape and extending laterally along a bottom face portion 24 are provided. The first connecting portion 53A is located with a predetermined space left with respect to the cover body 30, and the second connecting portion 53B is located with a predetermined space left with respect to the bottom face portion 24. In this case, a function and an effect similar to those of the first embodiment can also be obtained.

### Third Embodiment

FIG. 7 shows a battery cell 20A of an energy storage apparatus of a third embodiment. Similarly to the second embodiment, the battery cell 20A is different from that of the first embodiment only in a method for welding a reinforcing plate 52 to a long side surface portion 25, and other structures are the same as those of the first embodiment. In the third embodiment, a connecting portion 53 having a line shape and extending longitudinally along a short side surface portion 26 is provided. The connecting portion 53 is located with a predetermined space left with respect to the short side surface portion 26. In this case, a function and an effect similar to those of the first embodiment can also be obtained.

### Fourth Embodiment

FIG. 8 shows a battery cell 20A of an energy storage apparatus of a fourth embodiment. The battery cell 20A is different from that of the first embodiment in a shape of a reinforcing plate 52, and other structures are the same as those of the first embodiment. The reinforcing plate 52 is formed into an X shape extending radially from a central portion, which has a maximum deformation amount, of a long side surface portion 25. Similarly to the first embodiment, the reinforcing plate 52 is fixed to the long side surface portion 25 at a connecting portion 53 by welding, in a position where a predetermined space is left with respect to a peripheral portion of the long side surface portion 25.

In the fourth embodiment as described above, the reinforcing plate 52 extending toward the peripheral portion of the long side surface portion 25 from the portion having the maximum deformation amount is provided. Therefore, a function and an effect similar to those of the first embodiment can also be obtained. Moreover, since an area of the reinforcing plate 52 is smaller than that of the reinforcing plate 52 in the first embodiment, a weight of the energy storage apparatus can be further reduced in the fourth embodiment. Note that the shape of the reinforcing plate 52 is not limited to an X shape but is changeable as desired.

### Fifth Embodiment

FIG. 9 shows a battery cell 20A of an energy storage apparatus of a fifth embodiment. The battery cell 20A includes a reinforcing plate 52 having an uneven thickness, and other structures are the same as those of the first embodiment. Specifically, the reinforcing plate 52 has, on a surface facing a long side surface portion 25, a recessed portion 54 for allowing deformation (expansion) of the long side surface portion 25. The recessed portion 54 has a spherical shape in which a portion corresponding to a central portion, which has a maximum deformation amount, of the long side surface portion 25 is made deepest. As a method for fixing the reinforcing plate 52 to the long side surface portion 25, any one of the methods used in the first to third embodiments can be employed. By doing so, a function and an effect similar to those of the first embodiment can also be obtained. Moreover, the deformation amount of the reinforcing plate 52 can be reduced by the recessed portion 54.

As described above, the thickness and the shape of the reinforcing plate 52 to be fixed to the battery cell 20A are changeable as desired. Moreover, although the dimension of the reinforcing plate 52 is made identical to that of the long side surface portion 25, the dimension of the reinforcing plate 52 may be identical to that of the case 21 on the side of the long side surface portion 25 including the cover body 30, or may be slightly smaller than that of the long side surface portion 25. However, the dimension of the reinforcing plate 52 shall be slightly larger than that of the planar portion 42 even when the reinforcing plate 52 is made smaller than the long side surface portion 25. In this case, as long as the reinforcing plate 52 covers the planar portion 42, the reinforcing plate 52 may be disposed disproportionally to the left or right, or up or down. Moreover, welding by a laser and the like may be performed locally, in a continuous linear manner or in an intermittent linear manner, or in combination thereof as desired.

Moreover, the energy storage apparatus 10 of the present invention is not limited to the structures of the embodiments described above, and various changes can be made.

For example, as shown in FIG. 10, the battery cell 20 may include a resin insulating sheet 56 covering the electrode assembly 35. Alternatively, the battery cell 20 may include a resin spacer (not shown) between a bottom of the electrode assembly 35 and the bottom face portion 24 of the container 23, and between the end portion 39 of the electrode assembly 35 and the short side surface portion 26 of the container. In these cases, the connecting portion for fixing the reinforcing plate 52 is desirably formed in a portion of the container 23 that is not in contact with the insulating sheet 56 or the spacer.

Alternatively, the battery cell 20 may be in a state where the electrode assembly 35 is disposed in the case 21 in such a posture that the winding shaft Wa is disposed along the vertical direction (Z direction) of the case 21. Moreover, the electrode assembly is not limited to a flat winding type, but may be a lamination type in which a plurality of rectangular positive electrode assemblies, negative electrode assemblies, and separators are laminated. Furthermore, the energy storage device is not limited to a square battery in which an electrode assembly is accommodated in a case, but may be a laminated battery in which a laminate film seals a laminated electrode assembly. Any of the aspects is applicable as long as a reinforcing plate is fixed to the second surface on the opposite side of the first surface of the first energy storage device, the first surface facing the second energy storage device.

Moreover, the method for fixing the reinforcing plate to the first energy storage device is not limited to welding. The reinforcing plate may be fixed using an adhesive having high adhesiveness or may be fixed by mechanical engagement, and any other method can be employed.

As shown in FIG. 11, the thickness of the containers 23 of the pair of battery cells 20A may be made larger than the thickness of the containers 23 of the battery cells 20B between the battery cells 20A. With this configuration, the rigidity of the containers 23 of the battery cells 20A is made higher than the rigidity of the containers 23 of the battery cells 20B. Note that the electrode assembly 35 and the current collectors 45A, 45B accommodated in the case 21 are not shown in FIG. 11. According to this aspect, the battery cells 20A become exclusive components that are only disposed at the outermost ends of the battery module 18. However, since the rigidity of the battery cells 20A can suppress local expansion (deformation) due to the deterioration of the electrode assembly 35, a function and an effect similar to those of the embodiments can be obtained.

The energy storage apparatus 10 of the present invention can be used for driving a gasoline vehicle or a diesel vehicle including an internal combustion engine, and a hybrid vehicle including an internal combustion engine and an electric motor. Moreover, the energy storage apparatus 10 of the present invention can be used for driving a hybrid vehicle, and an electric vehicle including an electric motor.

### DESCRIPTION OF REFERENCE SIGNS

10 . . . energy storage apparatus
12 . . . outer case
13 . . . case main body
14 . . . long side wall
15 . . . short side wall
18 . . . battery module
20 . . . battery cell (energy storage device)
20A . . . battery cell at an outermost end
20B . . . battery cell in the middle part
21 . . . case
23 . . . container
24 . . . bottom face portion
25 . . . long side surface portion
25a . . . inner surface (first surface)
25b . . . outer surface (second surface)
26 . . . short side surface portion
27 . . . opening
30 . . . cover body
31 . . . positive electrode terminal
32 . . . negative electrode terminal
35 . . . electrode assembly
36 . . . positive electrode assembly
36a . . . active material
37 . . . negative electrode assembly
37a . . . active material
38 . . . separator
39 . . . end portion
40 . . . straight line
41 . . . curved portion
42 . . . planar portion
45A, 45B . . . current collector
46 . . . pedestal portion
47 . . . leg portion
50A to 50E . . . bus bar
52 . . . reinforcing plate
53, 53A, 53B . . . connecting portion
54 . . . recessed portion
56 . . . insulating sheet

1. An energy storage apparatus comprising plural energy storage devices arranged in a predetermined arrangement direction in a stacked manner, an energy storage device of the plural energy storage devices including an electrode assembly and a container accommodating the electrode assembly,
wherein the plural energy storage devices include:
a pair of first energy storage devices located at outermost ends in the arrangement direction; and
a second energy storage device located between the pair of first energy storage devices, and
rigidity of the container of a first energy storage device of the pair of the first energy storage devices is higher than rigidity of the container of the second energy storage device.

2. The energy storage apparatus according to claim 1, wherein the container of the first energy storage device includes:
a first surface facing an adjacent second energy storage device; and
a second surface opposite to the first surface, and
a reinforcing plate is fixed to the second surface.

3. The energy storage apparatus according to claim 2, wherein the energy storage device has a cover body sealing an opening of the container, and
the reinforcing plate is fixed to the container in a position where a predetermined space is left with respect to the cover body.

4. The energy storage apparatus according to claim 2, wherein the reinforcing plate is fixed to the container in a position where a predetermined space is left with respect to a bottom portion opposite to an opening of the container.

5. The energy storage apparatus according to claim 2, wherein the container has a long side surface extending in a direction crossing the arrangement direction to form the second surface, and a short side surface extending along the arrangement direction, and
the reinforcing plate is fixed to the long side surface in a position where a predetermined space is left with respect to the short side surface.

6. The energy storage apparatus according to claim 2, wherein the reinforcing plate is fixed to the container at a bonding portion by welding, and
the bonding portion is formed in a portion of the container that is not in contact with the electrode assembly.
